(19) United States
(12) Patent Application Publication
(10) Pub. No.: US 2014/0054836 A1
(43) Pub. Date: Feb. 27, 2014

(54) Sushi Cutter Tool

(71) Applicant: Huigang CHEN, Riccarton (NZ)

(72) Inventor: Huigang CHEN, Riccarton (NZ)

(21) Appl. No.: 13/952,689

(22) Filed: Jul. 29, 2013

(30) Foreign Application Priority Data
Aug. 24, 2012 (NZ) 602012

(51) Int. Cl. B26B 29/06

(52) U.S. Cl. CPC B26B 29/063
USPC 269/288

(57) ABSTRACT

A tool including a first section and a cutting block, where said first section is essentially an extended hollow member with a longitudinal aperture, wherein said first section further includes
a flange extending from each peripheral edge of the longitudinal aperture;
a second section;
a third section;
a lengthwise pivotable link which connects the second section and third section; and
a plurality of parallel first slots, where each said first slot is a transaxial aperture through at least the second and third sections;
   such that, when the first section is in a closed position, the combination of the cutting block and the first section are configured to maintain a food product in a predetermined shape as it is manually cut into sections.

### TECHNICAL FIELD

The present invention relates to a device which acts as a tool to assist with the manual cutting of a roll of food product, such as a roll of sushi.

### BACKGROUND ART

Preparation of rolled sushi involves creating a roll of sushi, which is generally wrapped in seaweed (nori), and cutting the roll along cross-sections into several pieces. When made in small proportions, cutting is done by eye, using a knife in one hand to cut the sushi, and using the other hand to hold the sushi roll. When cutting sushi manually the hand holding the roll can deform the roll, if this happens the pieces of sushi produced will not have the preferred cross section. In addition, as each cut is judged by eye, the roll may be cut unevenly, resulting in sushi pieces that are of different thicknesses.

Large-scale sushi production utilises machines with multiple knives at a predetermined distance from each other, which cut the roll or rolls simultaneously. These machines are expensive and are not feasible for use on a small scale, such as in a small sushi shop or in the home.

An object of the present invention is to provide a tool to assist a user with the manual cutting of a sushi roll, or other roll of food product, and/or provide the consumer with a useful choice.

Any discussion of the prior art throughout the specification is not an admission that such prior art is widely known or forms part of the common general knowledge in the field.

### DISCLOSURE OF INVENTION

The present invention provides a tool including a first section and a cutting block where said first section is essentially an extended hollow member with a longitudinal aperture, wherein said first section further includes
a flange extending from each peripheral edge of the longitudinal aperture;
a second section;
a third section;
a lengthwise pivotable link which connects the second section and third section; and
a plurality of parallel first slots, where each said first slot is a transaxial aperture through at least the second and third sections;
   such that, when the first section is in a closed position, the combination of the cutting block and the first section are configured to maintain a food product in a predetermined shape as it is manually cut into sections.

In a preferred form each first slot is spaced equidistantly from each immediately adjacent first slot.

Preferably the cutting block includes an exposed surface that is configured to complete an inner wall of the tool when said tool is in the closed position, where said inner wall is the surface of the tool configured to contact an exposed surface of the food product to be cut. In one preferred form said exposed surface, in cross section is flat or concave. In an alternative preferred form said exposed surface is dimensioned such that, in the closed position, it is configured to maintain the cross section of the food product essentially circular.

Preferably said first section includes a plurality of parallel second slots, where each said second slot is a transaxial aperture through at least the second and third sections. In a highly preferred form each said slot extends part way into each flange. Preferably each second slot is spaced equidistantly from each immediately adjacent second slot.

Preferably said first section further includes at least one handle configured to assist a user in pivoting the second section relative to the third section. Preferably there is one handle connected to each of the second and third sections. In a highly preferred form each handle extends away from a first end of the first section, where said first end is one distal end of the first section.

Preferably said extended hollow member is a tube with an essentially circular or rectangular cross section.

Preferably said pivotable link is a mechanical configuration that allows the second section and third section to pivot about a longitudinal axis of said pivotable link. Preferably said pivotable link is a series of hinges alternating with the slots along the length of the first section. In an alternative form said pivotable link is a portion of the first section which is a suitably flexible material such as rubber.

Preferably at least one flange is a strip of material, aligned lengthwise parallel to the centreline of the first section, with one peripheral edge coterminous with a matching peripheral edge of the longitudinal aperture. Preferably each flange extends away from the centre of the first section.

Preferably the food product to be manually cut is a sushi roll.

Preferably the cutting block includes a plurality of transaxial cutting grooves which are channels in the cutting block configured to align with a matching slot in the first section.

Preferably the cutting block includes a block groove which is dimensioned and configured to accept, and releasbly retain, one flange, a first flange. Preferably, where the cutting block includes a block groove, there is one handle attached to the other flange, a second flange.

In an alternative embodiment the cutting block has an inverted ‘T’ cross section.

Preferably the first section is biased towards the closed position by a bias means. In a highly preferred form the first section is spring biased towards the closed position.

Preferably each of the flanges are configured to rest against a complementary feature of the cutting block. In an alternative preferred form one flange, a first flange, is permanently or temporarily attached to the cutting block.

### BRIEF DESCRIPTION OF DRAWINGS

By way of example only, a preferred embodiment of the present invention is described in detail below with reference to the accompanying drawings, in which:

FIG. 1 shows an exploded view of a first embodiment of the tool;

FIG. 2 shows an end view of the first embodiment or second embodiment of the tool with a first variation of the cutting block;

FIG. 3 shows a side view of the second embodiment of the tool;

FIG. 4 shows an end view of third embodiment of the tool;

FIG. 5 shows a side view of a preferred form of the cutting block;

FIG. 6 shows an end view of the tool with a variation of the cutting block;

FIG. 7 shows an end view of a fourth embodiment of the tool

FIG. 8 is a graphical representation of a preferred method of using the tool.

FIG. 9 is an end view of a fifth embodiment of the tool which is a dual sushi roll variation of the tool in the closed position;

FIG. 10 is an end view of the fifth embodiment of the tool in the open position;

### DEFINITIONS

Flange: A strip or any elongated hollow or solid member aligned lengthwise parallel to an edge to which it is attached (or formed as part of), including a projecting flat rim, collar, or rib on an object, serving for strengthening or attachment or for maintaining position on a rail.

Transaxial: at right angles to the longitudinal (lengthwise) axis of a body in at least one plane.

Tube: an extended hollow member with an essentially circular or rectangular cross-section, though alternative cross sections may also be used.

The tool is described with specific reference to sushi but any food product that needs to be retained in a specific shape whilst being manually cut into sections can use the tool, for example sausage rolls and rolled sponge with cream or jam filling.

### BEST MODE FOR CARRYING OUT THE INVENTION

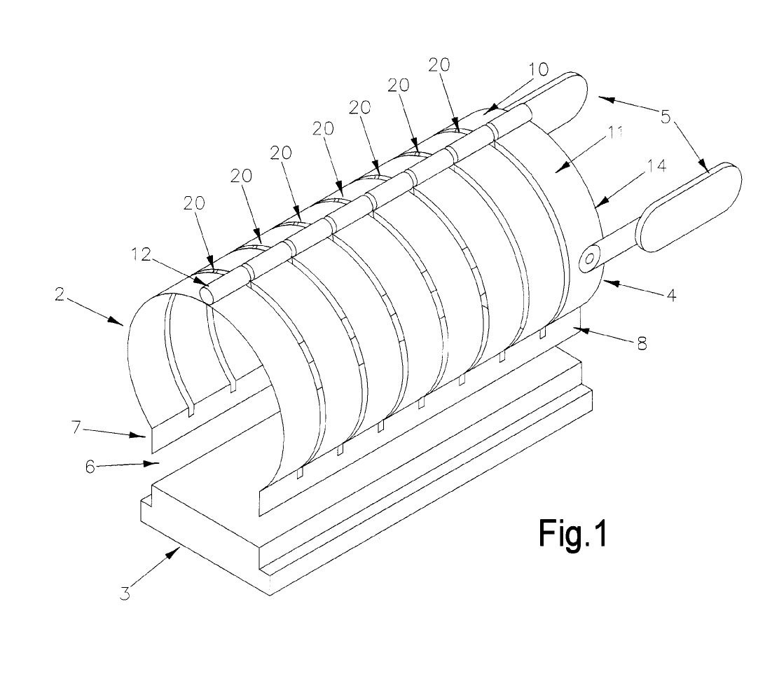

Referring to FIG. 1 an exploded view of a first embodiment of a tool (1) including a guide (2) and a first variation of the cutting block (3) is shown.

The guide (2) includes a first section (4) and two handles (5). The first section (4) is a tube, with a longitudinal aperture (6) extending the full length. Attached to each edge of the longitudinal aperture (6) is a flange (7,8).

In this first embodiment each flange (7,8) is a strip of material, aligned lengthwise parallel to the centreline of the first section (4), with one peripheral edge coterminous with a matching peripheral edge of the longitudinal aperture (6). Each flange (7,8) extends away from the centre of the first section (4), though not necessarily radially.

The first section (4) includes a second section (10) and a third section (11) pivotably connected by a pivotable link (12). Said pivotable link (12) lies parallel to, and is located directly opposite to, the centreline of the longitudinal aperture (6). Though this location is preferred in some embodiments the pivotable link (12) may lie parallel to the centreline of the longitudinal aperture (6) but not be directly opposite. Said pivotable link (12) may be one or more hinges of known type, a piece of flexible material such as rubber or a physical feature that allows the second section (10) and third section (11) to pivot with relation to each other.

The second and third sections (10,11) are made of a resilient but essentially rigid material such as food grade stainless steel or plastic, though similar food grade materials can be used. Noting that springy materials could be used for the second and third sections (10,11) providing they are dimensionally stable enough to maintain the required shape of the sushi (rolled food product).

One handle (5) is attached to the second section (10) and one handle (5) is attached to the third section (11). In this first embodiment each handle (5) lies parallel to the centreline of the longitudinal aperture (6) and extends beyond a first end (14) of the first section (4), where the first end (14) is one distal end of the first section (4). Each handle (5) lies approximately equidistant from the pivotable link (12).

The first section (4) further includes a plurality of parallel transaxial first slots (20) spaced equidistantly along the length of the first section (4). Each first slot (20) extends partially into each flange (7,8) and is dimensioned to accommodate a knife blade (not shown). In this first embodiment there are 7 first slots (20) shown which will allow a sushi roll (not shown) to be cut into 8 pieces, though if the ends need to be trimmed there may be nine first slots (20). The first slots (20) divide the pivotable link (12) up into a series of sub-sections.

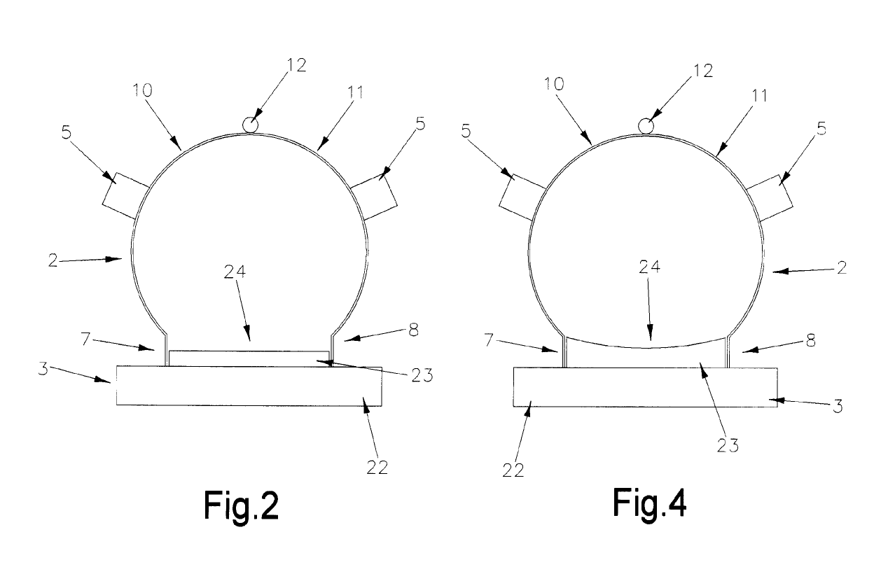

As shown in FIG. 2 the cutting block (3) of the first embodiment has an inverted ‘T’ cross section which includes a base (22) and an ‘I’ section (23). When viewed in cross section the ‘I’ section (23) extends away from the centre of the base (22). Said ‘I’ section (23) is dimensioned and configured to extend between and preferably contact a surface of the flanges (7,8) when the tool (1) is in use. The cutting block (3) is made of a material suitable for use as a cutting surface for food, for example materials such as wood and plastic. In the first embodiment the exposed distal end (24) of the ‘I’ section (23) is flat.

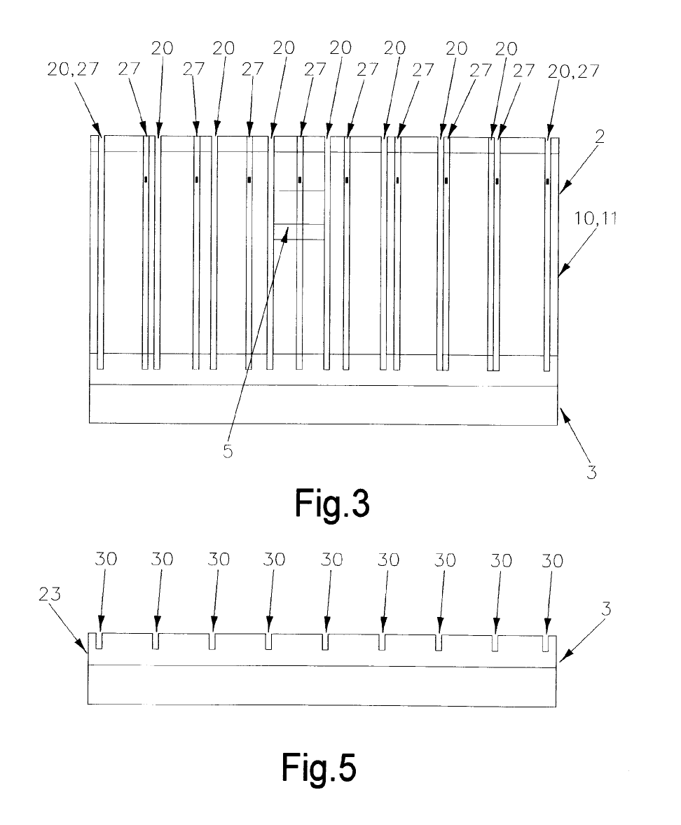

Referring to FIG. 3 a side view of a second embodiment of the tool (1) is shown. In this embodiment, in addition to the plurality of first slots (20), there is a plurality of second slots (27) which have a different spacing to the first slots (20). In addition the handles (5) are attached centrally to the second and third sections (10,11), in this case they may simply be blocks attached to the surface of the relevant section.

In FIG. 4 an end view of a third embodiment of the tool (1) is shown, in this embodiment the exposed distal end (24) of the ‘I’ section (23) of the cutting block (3) is concave. This concave exposed distal end (24) is intended to co-operate with the cross section of the guide (2) to maintain an essentially circular cross section of an item to be cut.

In FIG. 5 a side view of a preferred form of the cutting block (3) is shown, in this form the cutting block (3) includes a plurality of cutting grooves (30) that when the cutting block (3) is in use align with the matching slots (20,27) in the first section (4). Each cutting groove (30) is a channel in the ‘I’ section (23) perpendicular to the longitudinal axis of the cutting block (3).

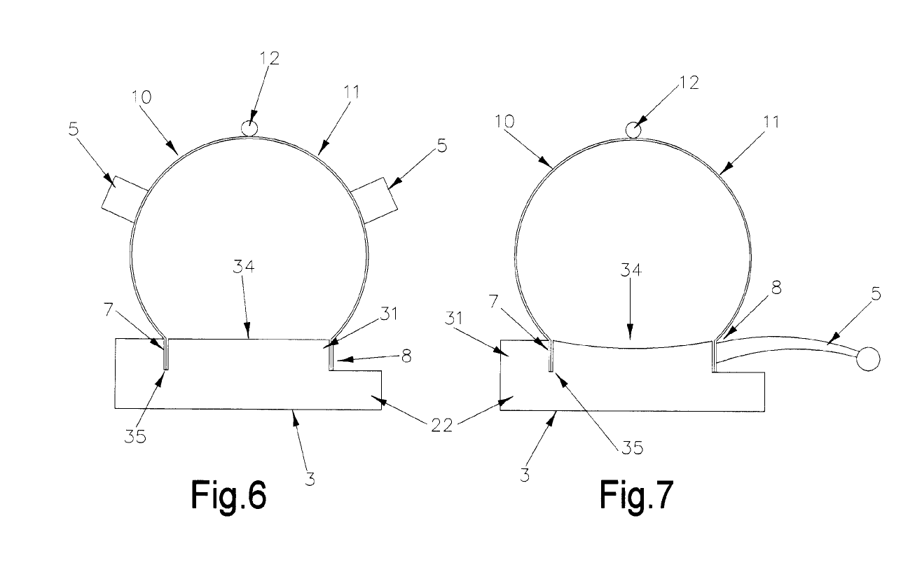

Referring to FIG. 6 an end view of the tool (1) with a variation of the cutting block (3) is shown. In this variation rather than having an inverted ‘T’ cross section the cutting block (3) is ‘L’ shaped. The cutting block (3) in this case includes an upright section (31) and a base (22) with the upright (31) of the ‘L’ being very much thicker than the base (22). The exposed distal end (34) of the upright (31) is flat and includes a block groove (35). Where the block groove (35) is a channel in the exposed distal end (34) running parallel to the length of the cutting block (3) dimensioned to accept one of the flanges (7,8), the first flange (7), when the tool (1) is in use. This variation of the cutting block (3) may include cutting grooves (30) similar to those shown in FIG. 5.

In FIG. 7 a fourth embodiment of the tool (1) is shown, in this embodiment the variation of cutting block (3) in FIG. 6 is used with one modification, the exposed distal end (34) of the upright (31) is curved rather than flat. As the distal end (34) is curved it allows the circular cross section of an item to be cut to be retained during cutting, this is particularly important for items such as sushi where it can be difficult to maintain this circular cross section against a flat surface. The fourth embodiment has only one handle (5), and this handle (5) is attached to the surface of one of the flanges (8), the second flange (8). The handle (5), when the tool (1) is viewed from end on, extends away from the first section (4).

In further embodiments (not shown) a combination of the cutting block (3) and handle (5) locations described earlier are used.

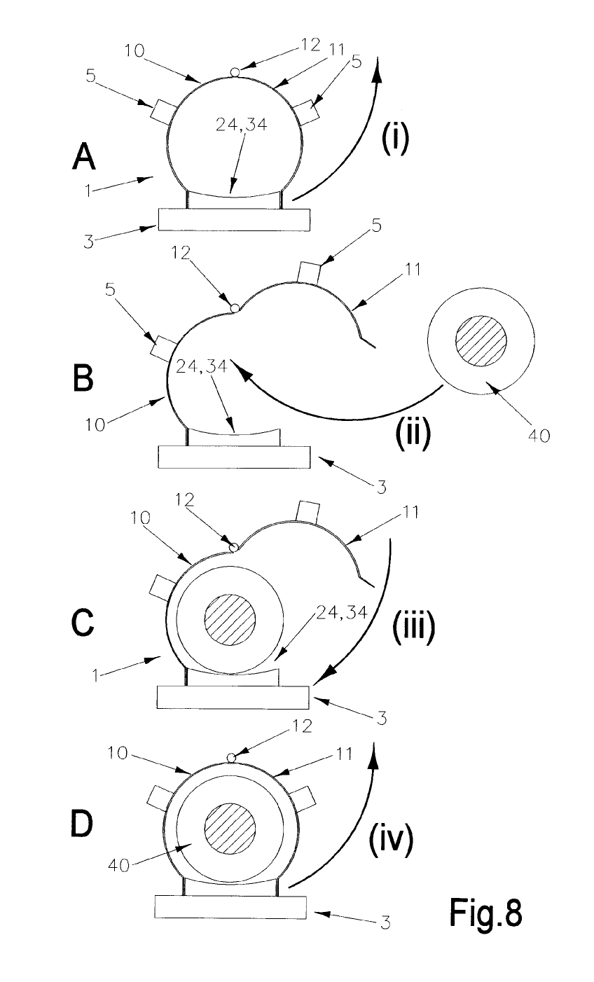

With reference to FIG. 8 a preferred method of using the tool (1) will be described, where the method includes the following steps in order:
A. Move the tool (1) into an open position;
B. Once in the open position a sushi roll (40) is inserted into the tool (1);
C. The tool (1) is closed and the sushi roll (4) is cut;
D. The tool (1) is opened and the cut sushi roll (40) pieces are removed.

In step A the third section (11) is pivoted away from the cutting block (3) in the direction of arrow (i) to move the first section (4) from a closed position (shown) into an open position (shown in step B).

In step B the tool 1 is shown in an open position. In this step a sushi roll (40) is placed into the tool (1) to rest on the exposed distal end (24, 34) of the cutting block (3), shown as arrow (ii).

In step C the third section is moved in the direction of arrow (iii) to move the first section (4) to the shown closed position. In the closed position a user passes a knife (not shown) through each required slot (20, 27) down until it contacts the cutting block (3) cutting the retained sushi roll (40) into the desired number of pieces. As can be seen the peripheral surface of the sushi roll is supported by the combination of the inner surface of the guide (2) and the exposed distal end (24) of the cutting block (3) during the cutting stage. As such the sushi roll retains the required cross sectional shape, for many applications this will be a circular or essentially circular cross section, though it can be a square or rectangular cross section.

In step D the closed first section (4) is opened by moving the third section (11) in the direction of arrow (iv) into the open position. In the open position the cut pieces of the sushi roll (40) can be removed from the tool (1).

Though the slots (20, 27) are shown perpendicular to the centreline of the first section (4) there is no reason why these could not be angled so that elliptical or angle sushi pieces were created. Further, though the slots (20, 27) are described as being parallel there is no reason why they need to be for some applications, though in general they will be.

It is preferred that in the closed position that the inner surfaces of the first section (4) contact the outer surface of the sushi roll (40) sufficiently closely to retain the desired shape of the sushi roll (40) as it is being cut. This may mean that pressure is applied to the sushi roll (40), this pressure may be governed by the pressure the user applies to the handle/s (5) or some form of biasing means. This also means that the exposed distal end (24) of the cutting block (2) needs to act in conjunction with the inner surface of the guide to retain the desired cross section.

In further embodiments there may be additional slots (20,27), or plurality of slots (20,27) for cutting different numbers of pieces.

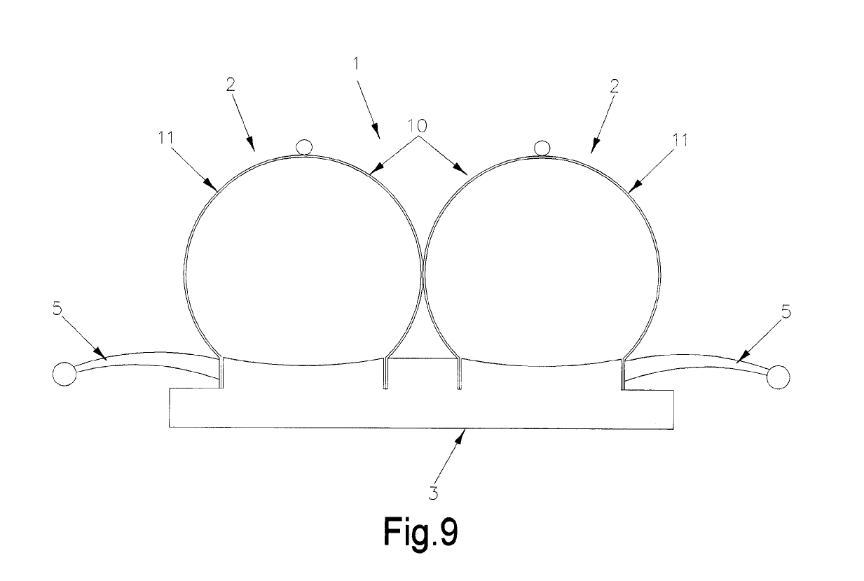

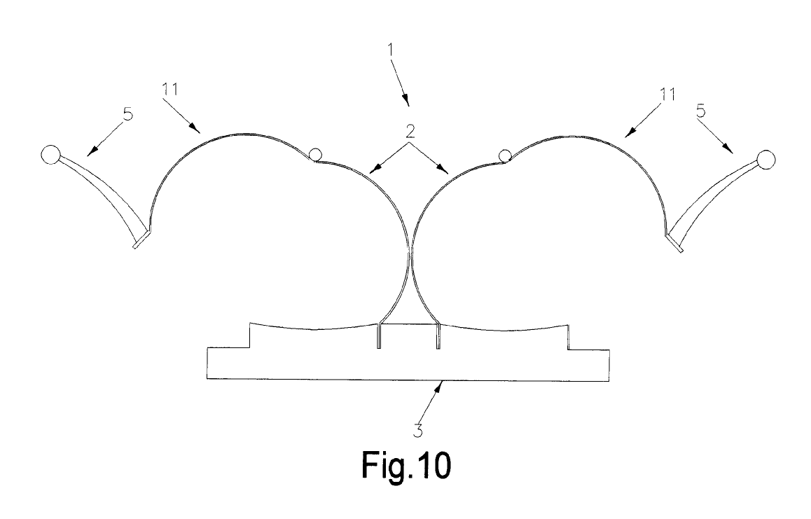

In a fifth embodiment as shown in FIGS. 9 and 10 there are two guides (1) attached by adjacent second sections (10), such that the slots (20,27) are aligned. FIG. 9 shows this embodiment in the closed position and FIG. 10 shows this embodiment in the open position. This fifth embodiment allows two rolls of sushi to be cut simultaneously, one retained in each of the separate guides (2), and though shown with a specific form of cutting block (3) any variation can be used. This form of the tool (1) can be used to cut two sushi rolls simultaneously or a single sushi roll as each side can be separately closed.

Though the pivotable link (12) is shown immediately opposite the centreline of the longitudinal aperture (6) it may in fact be located closer one flange (7,8) than the other (7,8). For example it may be located a quarter or a third (or any other dimension) of the way around the circumference of the first section (4).

In alternative embodiments one or both said flanges (7,8) could incorporate an expanded section that is configured to engage with a complementary feature in the cutting block (3). For example the feature could be a wire or a folded section of the flange (7,8) in question. It should also be noted that the flange can be a strip or any elongated hollow or solid member aligned lengthwise parallel to the centreline of the first section (4), with one peripheral edge coterminous with a matching peripheral edge of the longitudinal aperture (6).

### KEY

1. Tool;
2. guide;
3. cutting block;
4. first section;
5. handles;
6. longitudinal aperture;
7. flange (first);
8. flange (second).
9. •
10. second section;
11. third section;
12. pivotable link;
13. •
14. first end (of the first section);
15. •
16. •
17. •
18. •
19. •
20. first slots;
21. •
22. base (of cutting block);
23. ‘I’ Section of cutting block;
24. exposed distal end (of the ‘I’ section);
25. •
26. •
27. second slots;
28. •
29. •
30. cutting grooves;
31. upright (variation of the cutting block);
32. ;
33. •
34. exposed distal end (of the upright).
35. block groove (in the variation of the cutting block);
36. •

1. A tool including a first section and a cutting block, where said first section is essentially an extended hollow member with a longitudinal aperture, wherein said first section further includes
a flange extending from each peripheral edge of the longitudinal aperture;
a second section;
a third section;
a lengthwise pivotable link which connects the second section and third section; and
a plurality of parallel first slots, where each said first slot is a transaxial aperture through at least the second and third sections;
such that, when the first section is in a closed position, the combination of the cutting block and the first section are configured to maintain a food product in a predetermined shape as it is manually cut into sections.

2. The tool as claimed in claim 1 characterised in that, each first slot is spaced equidistantly from each immediately adjacent first slot.

3. The tool as claimed in claim 1 characterised in that, the cutting block includes an exposed surface that is configured to complete an inner wall of the tool when said tool is in the closed position, where said inner wall is the surface of the tool configured to contact an exposed surface of the food product to be cut.

4. The tool as claimed in claim 3 characterised in that, said exposed surface, in cross section is flat or concave.

5. The tool as claimed in claim 3 characterised in that, the exposed surface is dimensioned such that, in the closed position, it is configured to maintain the cross section of the food product essentially circular.

6. The tool as claimed in claim 1 characterised in that, first section includes a plurality of parallel second slots, where each said second slot is a transaxial aperture through at least the second and third sections.

7. The tool as claimed in claim 6 characterised in that each second slot is spaced equidistantly from each immediately adjacent second slot

8. The tool as claimed in claim 1 characterised in that, each slot extends part way into each flange.

9. The tool as claimed in claim 1 characterised in that, the first section further includes at least one handle configured to assist a user in pivoting the second section relative to the third section.

10. The tool as claimed in either claim 9 characterised in that, each handle extends away from a first end of the first section, where said first end is one distal end of the first section.

11. The tool as claimed in claim 1 characterised in that, the extended hollow member is a tube with an essentially circular or rectangular cross section.

12. The tool as claimed in claim 1 characterised in that, the pivotable link is a series of hinges alternating with the slots along the length of the first section.

13. The tool as claimed in claim 1 characterised in that, the pivotable link is a portion of the first section which is a flexible material.

14. The tool as claimed in claim 1 characterised in that, at least one flange is a strip of material, aligned lengthwise parallel to the centreline of the first section, with one peripheral edge coterminous with a matching peripheral edge of the longitudinal aperture.

15. The tool as claimed in claim 1 characterised in that, the food product to be manually cut is a sushi roll.

16. The tool as claimed in claim 1 characterised in that, the cutting block includes a plurality of transaxial cutting grooves which are channels in the cutting block configured to align with a matching slot in the first section.

17. The tool as claimed in claim 1 characterised in that, the cutting block includes a block groove which is dimensioned and configured to accept, and releasbly retain, one flange, a first flange.

18. The tool as claimed in claim 1 characterised in that, the cutting block has an inverted ‘T’ cross section.

19. The tool as claimed in claim 1 characterised in that, the first section is biased towards the closed position by a bias means.

20. The tool as claimed in claim 19 characterised in that, the first section is spring biased towards the closed position.

21. The tool as claimed in claim 1 characterised in that, each of the flanges are configured to rest against a complementary feature of the cutting block.

22. The tool as claimed in claim 1 characterised in that, one flange is permanently or temporarily attached to the cutting block.

23. The tool as claimed in claim 1 which includes two first sections which are parallel and coterminous along the length of adjacent second sections.
